(19) United States
(12) Patent Application Publication
(10) Pub. No.: US 2013/0147855 A1
(43) Pub. Date: Jun. 13, 2013

(54) ELECTRONIC DEVICE HAVING DISPLAY AND METHOD FOR ADJUSTING BRIGHTNESS OF DISPLAY

(71) Applicants: Xing-Zhen WANG, Shenzhen City (CN); Lei SHI, Shenzhen City (CN)

(72) Inventors: Xing-Zhen WANG, Shenzhen City (CN); Lei SHI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/571,376

(22) Filed: Aug. 10, 2012

(30) Foreign Application Priority Data
Dec. 9, 2011 (CN) 201110409261.5

(51) Int. Cl. G09G 5/10

(52) U.S. Cl. 345/690

(57) ABSTRACT

An electronic device includes a display, an illumination sensor, a distance detecting unit, a storage unit and a control unit. The illumination sensor periodically detects a current ambient illumination. The distance detecting unit periodically detects a current distance between a user and the electronic device. The control unit determines a corresponding current illumination level, and compares the current illumination level with a historical illumination level. If the current illumination level differs from the historical illumination level, the control unit further compares the current distance with a historical distance. If the current distance differs from the historical distance, the control unit maintains the brightness of the display; otherwise, the control unit adjusts the brightness of the display according to the illumination level. Then, the control unit stores the current illumination level and the current distance in the storage unit to update the historical illumination level and the historical distance.

### BACKGROUND

1. Technical Field

The present disclosure relates to electronic devices, and particularly, to an electronic device having a display and a method for adjusting brightness of the display.

2. Description of Related Art

Some computers have an automatic brightness control function for automatically adjusting the brightness of its display screen according an ambient illumination. Typically, the brightness of the display screen is adjusted in such a way that the display screen is bright in a brightly lit environment but is dark in a dimly lit environment.

However, when a user or other object inadvertently shadows the ambient light of the detected area where the illumination sensor senses, the brightness of the display screen may be incorrectly adjusted to be dark.

Therefore, what is needed is a means to solve the problem described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of an electronic device having a display, in accordance with an exemplary embodiment.

FIG. 2 is a flowchart of a method for adjusting brightness of a display, in accordance with an exemplary embodiment.

### DETAILED DESCRIPTION

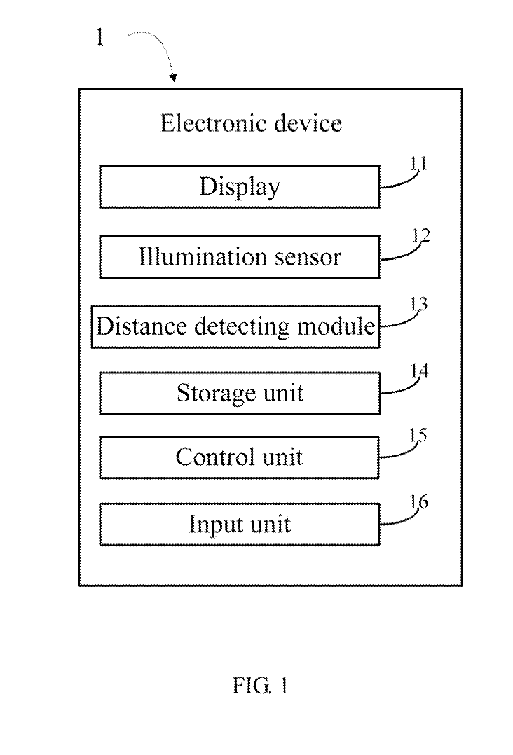

FIG. 1 is a block diagram of an electronic device 1 in accordance to an exemplary embodiment. The electronic device 1, such as a computer or a mobile phone, includes a display 11 for displaying a variety of information. The brightness of the display 11 can be adjusted when the electronic device 1 is under an automatic mode or a manual mode. When the electronic device 1 is under the manual mode, the brightness of the display 11 is adjusted manually. When the electronic device 1 is under the automatic mode, the electronic device 1 automatically detects an ambient illumination of an environment the electronic device 1 located in. If a varied ambient illumination is detected, the electronic device 1 further detects a distance between the user and the display 11. If a varied distance between the user and the display 11 is detected, the electronic device 1 determines that the detected ambient illumination varies because the user approaches or leaves the display 11, and then maintains the current brightness of the display 11. If a constant distance is detected, the electronic device 1 adjusts the brightness of the display 11 correspondingly.

In the embodiment, the electronic device 1 further includes an illumination sensor 12, a distance detecting unit 13, a storage unit 14, and a control unit 15. The illumination sensor 12 periodically detects the current ambient illumination when the electronic device 1 is under the automatic mode. In the embodiment, the illumination sensor 12 is a photosensitive diode, a photosensitive triode, or a photosensitive resistor. The detection of the ambient illumination implemented by the photosensitive diode, the photosensitive triode, and the photosensitive resistor is a well known technique, thus a detailed description thereof is omitted herein for conciseness in explanation.

The distance detecting unit 13 periodically detects the current distance between the user and the electronic device 1 when the electronic device 1 is under the automatic mode.

In the embodiment, the detected ambient illumination is divided into ten illumination levels, namely, a first illumination level to a tenth illumination level, and each illumination level corresponds to a predefined ambient illumination range. More specifically, the first illumination level corresponds to a lowest ambient illumination range, and the tenth illumination level corresponds to a greatest ambient illumination range. For example, the first illumination level corresponds to a brightness range of 0˜10 candela, the second illumination level corresponds to a brightness range of 1˜20 candela, and so forth.

The control unit 15 obtains the detected current distance and the detected current ambient illumination, determines a current illumination level corresponding to the detected current ambient illumination. In the embodiment, the control unit 15 determines the brightness range which the detected ambient illumination falls to determine the illumination level corresponding to the detected ambient illumination. Then, the control unit 15 stores the determined current illumination level and the detected current distance in the storage unit 14. The current illumination level determined previously is a historical illumination level, and the current distance detected previously is a historical distance. After the current illumination level is determined, the current illumination level replaces the historical illumination level to update the historical illumination level; similarly, after the current distance is obtained, the current distance replaces the historical distance to update the historical distance. The control unit 15 further compares the current illumination level with the historical illumination level. If the current illumination level differs from the historical illumination level, the control unit 15 further compares the current distance with the historical distance. If the current distance differs from the historical distance, the control unit 15 maintains the brightness of the display 11; otherwise, the control unit 15 adjusts the brightness of the display 11 according to the determined illumination level.

In the embodiment, the illumination sensor 12 and the distance detecting unit 13 stop detecting the current ambient illumination and the current distance when the electronic device 1 is in a stand-by state, thereby avoiding adjusting the brightness of the display 11 when the user does not use the electronic device 1. The detecting period of the illumination sensor 12 and the distance detecting unit 13 can be set by the user.

In the embodiment, the storage unit 14 further stores a brightness table, and the brightness table includes a variety of illumination levels and an optimal brightness of the display 11 associated with each illumination level. For example, the first illumination level is associated with an optimal brightness of 10%, and the second illumination level is associated with an optimal brightness of 20%, and so forth. As mentioned above, after determining the illumination level corresponding to the detected ambient illumination, the control unit 15 determines the associated optimal brightness based on the brightness table, and then adjusts the brightness of the display 11 according to the determined optimal brightness.

In the embodiment, the electronic device 1 further includes an input unit 16. The input unit 16, such as a variety of mechanical buttons or touch-sensitive buttons provided on the electronic device 1, is provided for the user to manually adjust the brightness of the display 11 under the manual mode and then generates a first instruction signal correspondingly. The control unit 15 adjusts the brightness of the display 11 only according to the first instruction signal when the electronic device 1 is under the manual mode. In the embodiment, the input unit 12 is further for the user to manually select the manual mode or the automatic mode, and then generates a second instruction signal. The control unit 15 controls the electronic device 1 to enter the corresponding mode according to the second instruction signal.

In the embodiment, when the electronic device 1 is under the automatic mode, the control unit 15 adjusts the brightness of the display 11 further according to a ratio (labeled as R) based on an actual brightness of the display 11 adjusted according to the first instruction signal with respect to the optimal brightness of the display 11 associated with the current illumination level. In the embodiment, the ratio R is obtained by the control unit 15 and then stored in the storage unit 14 when the electronic device 1 is under the manual mode. In this case, the illumination sensor 12 also detects the ambient illumination when the electronic device 1 is under the manual mode. After responding to the first instruction signal, the control unit 15 adjusts the brightness of the display 11 to the actual brightness. Then, the control unit 15 obtains the optimal brightness associated with the corresponding illumination level, thus the ratio R is obtained based on the actual brightness with respect to the obtained optimal brightness.

When the electronic device 1 is switched to the automatic mode, the control unit 15 obtains the optimal brightness associated with the determined illumination level based on the brightness table, and then calculates a actual brightness by multiplying the obtained optimal brightness and the ratio R, thus the brightness of the display 11 is allowed to be adjusted to the calculated actual brightness.

For example, at one moment when the electronic device 1 is under the manual mode, the user manually adjusts the brightness of the display 11 to be 30%. At this moment, the ambient illumination detected by the illumination sensor 12 corresponds to the second illumination level, and the second illumination level is associated with the optimal brightness of 20%. In this case, the ratio R is obtained to be 1.5, indicating that the actual brightness of the display 11 that the user prefers is 1.5 times than the optimal brightness preset for the display 11. If the electronic device 1 is switched to the automatic mode and the detected ambient illumination varies to correspond to the third illumination level, the control unit 15 obtains the optimal brightness 30% associated with the third illumination level, and then adjusts the brightness of the display 11 to 45% that is calculated by multiplying the obtained brightness 30% and the calculated ratio 1.5. Therefore, the brightness of the display 11 is adjusted not only according to the ambient illumination, but also according to the user's preference.

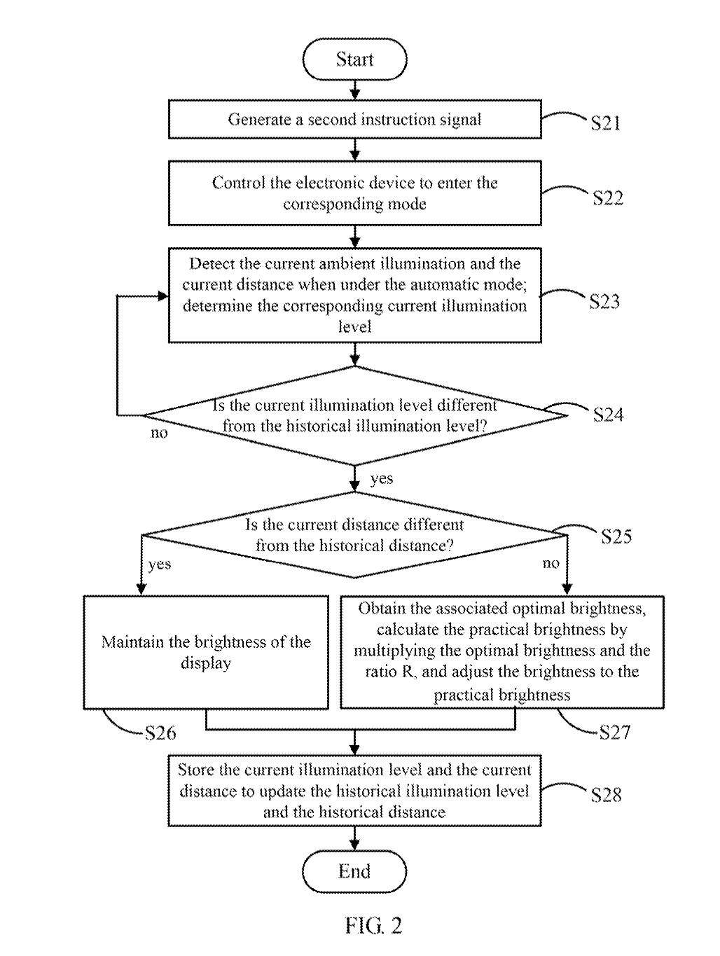

FIG. 2 is a flowchart of a method for adjusting the brightness of the display 11 included in the electronic device 1, in accordance with an exemplary embodiment.

In step S21, the input unit 12 generates a second instruction signal when the user manually selects the manual mode or the automatic mode.

In step S22, the control unit 15 controls the electronic device 1 to enter the corresponding mode according to the second instruction signal.

In step S23, when the electronic device 1 is under the automatic mode, the illumination sensor 12 periodically detects the current ambient illumination; the distance detecting unit 13 periodically detects the current distance between the user and the electronic device 1; and the control unit 15 determines the current illumination level corresponding to the detected current ambient illumination.

In step S24, the control unit 15 compares the current illumination level with the historical illumination level, if the current illumination level differs from the historical illumination level, the procedure goes to step S25; otherwise, the procedure goes back to step S23.

In step S25, the control unit 15 compares the current distance with the historical distance, if the current distance differs from the historical distance, the procedure goes to step S26; otherwise, the procedure goes to step S27.

In step S26, the control unit 15 maintains the brightness of the display 11.

In step S27, the control unit 15 obtains the optimal brightness of the display 11 associated with the current illumination level, calculates the actual brightness of the display 11 by multiplying the obtained optimal brightness and the ratio R, and then adjusts the brightness of the display 11 to the calculated actual brightness.

In step S28, the control unit 15 stores the current illumination level and the current distance in the storage unit 14 to update the historical illumination level and the historical distance.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device having a display, comprising:
an illumination sensor to periodically detect a current ambient illumination;
a distance detecting unit to periodically detect a current distance between a user and the electronic device;
a storage unit; and
a control unit configured to:
determine a current illumination level corresponding to the detected current ambient illumination;
compare the current illumination level with a historical illumination level;
compare the current distance with a historical distance if the current illumination level differs from the historical illumination level;
maintain the brightness of the display if the current distance differs from the historical distance;
adjust the brightness of the display according to the determined illumination level if the current distance is the same as the historical distance; and
store the current illumination level and the current distance in the storage unit to update the historical illumination level and the historical distance.

2. The electronic device of claim 1, wherein the illumination sensor and the distance detecting unit stop detecting the current ambient illumination and the current distance when the electronic device is in a stand-by state.

3. The electronic device of claim 1, wherein a detecting period of the illumination sensor and the distance detecting unit is set by the user.

4. The electronic device of claim 1, wherein the illumination level ranges from a first illumination level to a tenth illumination level; each illumination level corresponds to a predefined ambient illumination range; and the control unit is configured to obtain the brightness range which the detected ambient illumination falls to determine the illumination level corresponding to the detected ambient illumination.

5. The electronic device of claim 1, wherein the storage unit is configured to store a brightness table; the brightness table comprises a plurality of illumination levels and an optimal brightness of the display associated with each illumination level; the control unit is configured to determine the associated optimal brightness based on the brightness table, and then adjust the brightness of the display according to the determined optimal brightness.

6. The electronic device of claim 5, further comprising an input unit, wherein the control unit is further configured to adjust the brightness of the display only according to a first instruction signal from the input unit.

7. The electronic device of claim 6, wherein the control unit is further configured to adjust the brightness of the display according to a ratio stored in the storage unit, that is, the control unit obtains the optimal brightness associated with the determined illumination level based on the brightness table, calculates a actual brightness by multiplying the obtained optimal brightness and the ratio, and then adjusts the brightness of the display to the calculated actual brightness.

8. The electronic device of claim 7, wherein the control unit is further configured to obtain the optimal brightness associated with the detected ambient illumination after the brightness of the display is adjusted to a actual brightness according to the first instruction signal, obtain the ratio based on the actual brightness with respect to the obtained optimal brightness, and then store the obtained ratio in the storage unit.

9. A method for adjusting brightness of the display, the display used in an electronic device, the method comprising:
periodically detecting a current ambient illumination and a current distance between a user and the electronic device;
determining a current illumination level corresponding to the detected current ambient illumination;
comparing the current illumination level with a historical illumination level;
comparing the current distance with a historical distance if the current illumination level differs from the historical illumination level;
maintaining the brightness of the display if the current distance differs from the historical distance; and adjusting the brightness of the display according to the determined illumination level if the current distance is the same as the historical distance; and
storing the current illumination level and the current distance in a storage unit of the electronic device to update the historical illumination level and the historical distance.

10. The method of claim 9, wherein the step adjusting the brightness of the display according to the determined illumination level if the current distance is the same as the historical distance further comprising:
determining an optimal brightness associated with the determined illumination level based on a brightness table stored in the storage unit, the brightness table comprising a plurality of illumination levels and an optimal brightness of the display associated with each illumination level; and
adjusting the brightness of the display according to the determined optimal brightness.

11. The method of claim 10, wherein the step adjusting the brightness of the display according to the determined optimal brightness further comprising:
calculating an actual brightness by multiplying the obtained optimal brightness and a ratio stored in the storage unit, wherein the ratio is obtained based on a actual brightness of the display adjusted according to a user input with respect to the optimal brightness associated with the current illumination level; and
adjusting the brightness of the display to the calculated actual brightness.
